(19) United States
(12) Patent Application Publication
(10) Pub. No.: US 2024/0194922 A1
(43) Pub. Date: Jun. 13, 2024

(54) HYDROGEN PUMP FOR A REDOX FLOW BATTERY

(71) Applicant: ESS TECH, INC., Wilsonville, OR (US)

(72) Inventors: Thiago Groberg, Tigard, OR (US); Craig Evans, West Linn, OR (US)

(21) Appl. No.: 18/537,673

(22) Filed: Dec. 12, 2023

Related U.S. Application Data
(60) Provisional application No. 63/387,077, filed on Dec. 12, 2022.

(51) Int. Cl. H01M 8/18; F04D 25/02; F04D 29/28; F04D 29/42; F04D 29/66; H01M 8/04082; H01M 8/04089; H01M 8/06

(52) U.S. Cl. CPC H01M 8/188; F04D 25/02; F04D 29/281; F04D 29/4206; F04D 29/662; H01M 8/04089; H01M 8/04201; H01M 8/0693

(57) ABSTRACT

Systems and methods are provided for actively directing hydrogen flow in an electrochemical cell system. The electrochemical cell system includes a component configured to receive hydrogen gas, one or more hydrogen blower assemblies positioned upstream and/or downstream of the component. The one or more hydrogen blowers include at least one sensor positioned on an outer surface of the one or more hydrogen blower assemblies and a controller including instructions to generate a notification in response to an output of the at least one sensor being outside of a target range.

### CROSS REFERENCE TO RELATED APPLICATIONS

The present application claims priority to U.S. Provisional Application No. 63/387,077 entitled “HYDROGEN PUMP FOR A REDOX FLOW BATTERY” filed Dec. 12, 2022. The entire contents of the above identified application is hereby incorporated by reference for all purposes.

### FIELD

The present description relates generally to a hydrogen pump configured for use in an electrochemical cell system.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. Various side reactions may compete with the Fe²⁺ reduction, including proton reduction, iron corrosion, and iron plating oxidation:

H⁺+e⁻↔½H₂ (proton reduction) (1)

Fe⁰+2H⁺↔Fe²⁺+H₂ (iron corrosion) (2)

2Fe³⁺+Fe⁰↔3Fe²⁺ (iron plating oxidation) (3)

As most side reactions occur at the plating electrode, IFB cycling capabilities may be limited by available iron plating on the plating electrode. Exemplary attempts to ameliorate iron plating loss have focused on catalytic electrolyte rebalancing to address hydrogen (H₂) gas generation from equations (1) and (2) and electrolyte charge imbalances (e.g., excess Fe³⁺) from equation (3) and ion crossover via equation (4):

Fe³⁺+½H₂→Fe²⁺+H⁺ (electrolyte rebalancing) (4)

To rebalance electrolyte via the electrolyte rebalancing reaction (equation 4), the redox flow battery system may include a rebalancing reactor wherein hydrogen gas is reacted with electrolyte, often with a catalyst. The source of hydrogen gas for the electrolyte rebalancing reaction may be hydrogen evolved from side reactions and/or hydrogen supplied from a separate hydrogen tank. For this reason, the redox flow battery system may demand transfer of hydrogen from storage areas (either a headspace of the electrolyte tank or a supplementary tank) to the rebalancing reactor and any unreacted hydrogen from the rebalancing reactor back to the storage areas. However, commercially available hydrogen pumps may be too large to be readily incorporated into the redox flow battery system for facilitating hydrogen delivery. Furthermore, due to the highly volatile and explosive nature of hydrogen gas, materials able to accommodate a reactivity of hydrogen and withstand the corrosive environment of the redox flow battery system are demanded for components used for hydrogen management.

In some examples, flow of hydrogen gas within a redox flow battery system may be addressed using venturi injectors to inject the hydrogen gas into a liquid stream, pumping the liquid using a dedicated liquid pump, and then removing the hydrogen gas from the liquid at the desired location using a liquid/gas separator. However, this system of moving hydrogen gas introduces multiple points of potential mechanical degradation and leakage between the dedicated liquid pump, venturi injectors, and liquid/gas separator. Further, the dedicated liquid pump increases a parasitic power load on the redox flow battery system. The added equipment also increases a footprint and heat load of the redox flow battery system.

In one example, an electrochemical cell system comprises a component configured to receive hydrogen gas, one or more hydrogen blower assemblies, wherein the one or more hydrogen blower assemblies are positioned upstream and/or downstream of the component, and wherein the one or more hydrogen blower assemblies include at least one sensor positioned on an outer surface of the one or more hydrogen blower assemblies, and a controller, including executable instructions stored on non-transitory memory that, when executed, cause the controller to: generate a notification in response to an output of the at least one sensor being outside of a target range. In this way, hydrogen flow within the electrochemical cell system may be controlled by a single assembly occupying a small foot print. Additionally, the hydrogen blower assembly may be configured to separate energized components from a path of hydrogen flow.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a hydrogen blower assembly.

FIG. 2 shows a first cross section view of the hydrogen blower assembly

FIG. 3 shows a second cross section view of the hydrogen blower assembly

FIG. 4. shows a cross section view of a motor and coupler of the hydrogen blower assembly.

FIG. 5. shows a flow chart of an example of a method for operating a hydrogen blower assembly.

FIG. 6 shows a cross section view of a first alternate embodiment of a hydrogen blower assembly.

FIG. 7 shows a second alternate embodiment of a hydrogen blower assembly.

FIG. 8 shows an exploded view of the second alternate embodiment of the hydrogen blower assembly.

FIG. 9 shows a cross section view of the second alternate embodiment of the hydrogen blower assembly.

### DETAILED DESCRIPTION

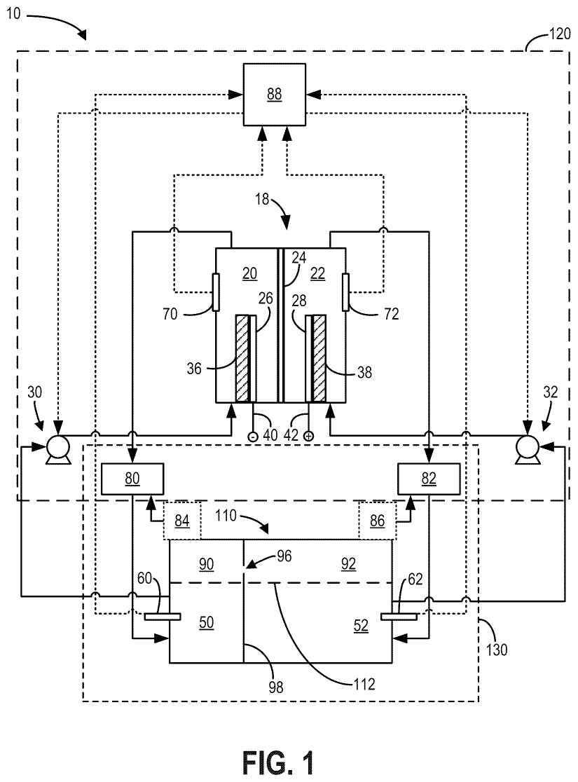

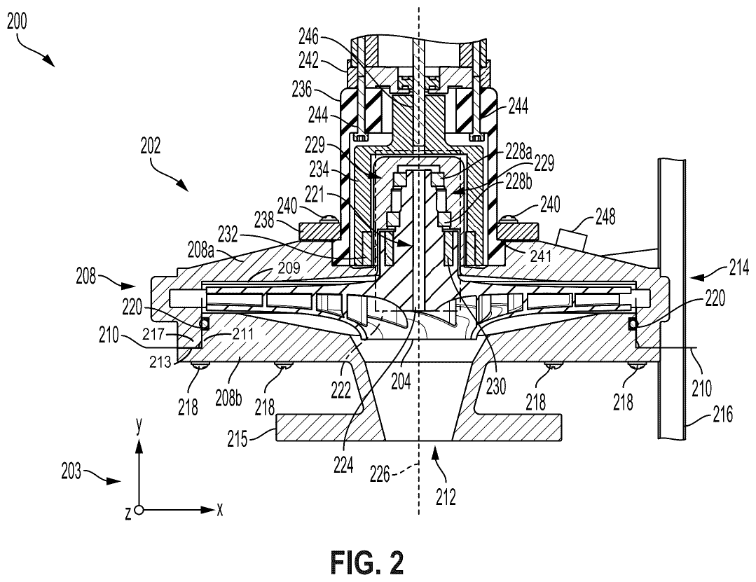

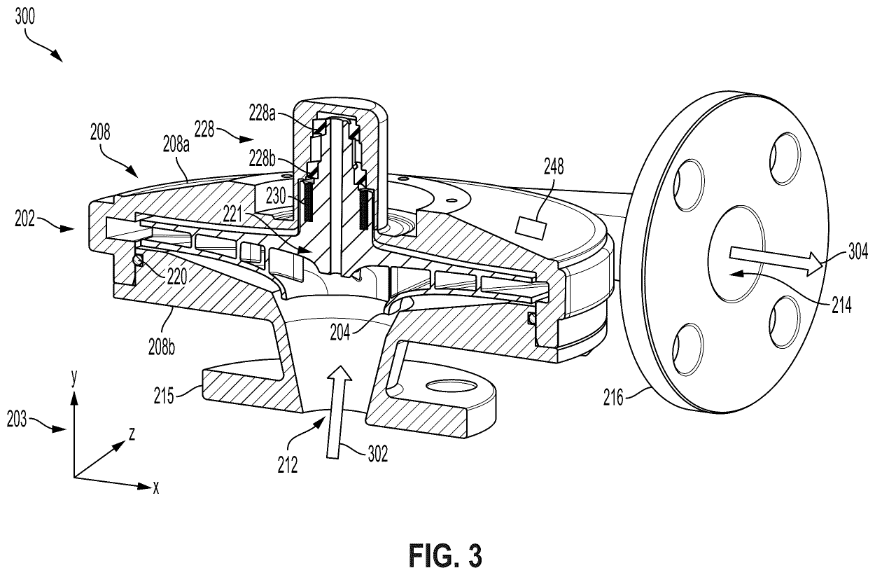

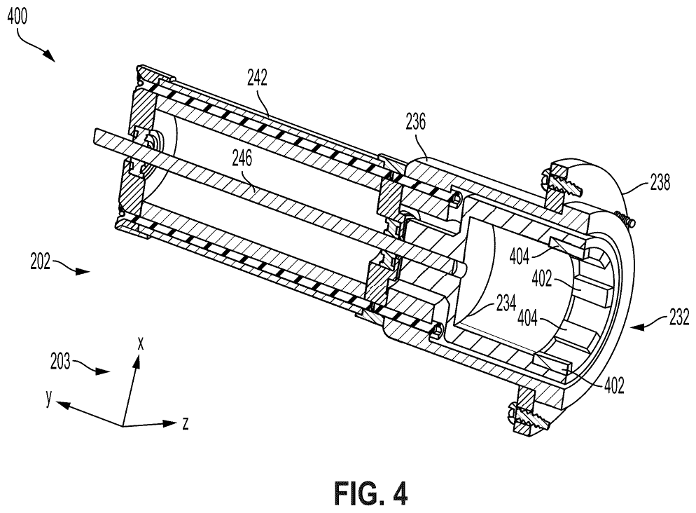

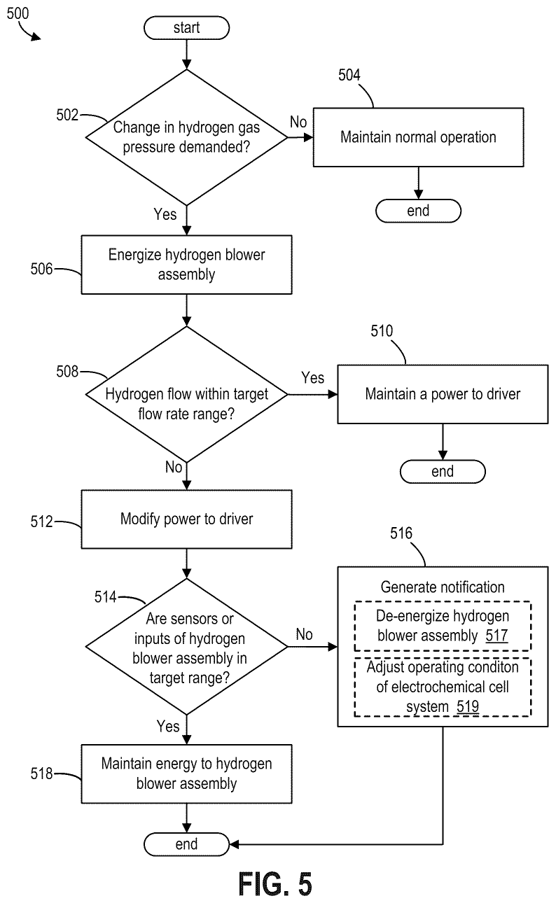

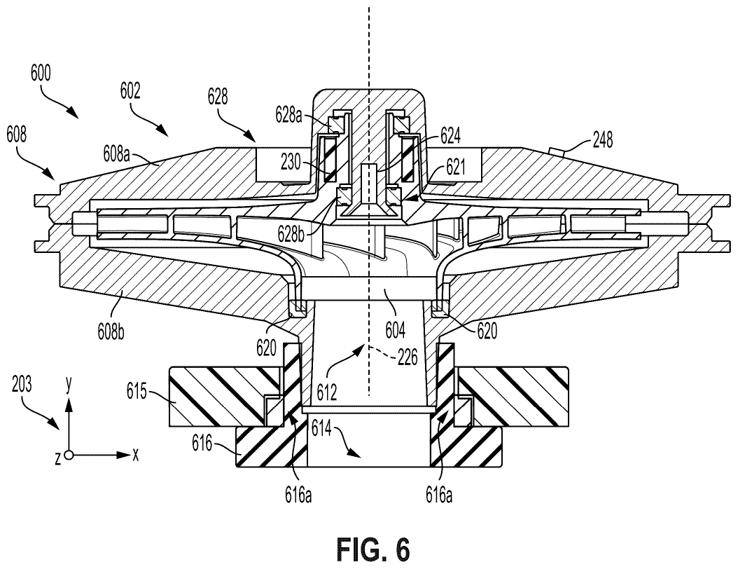

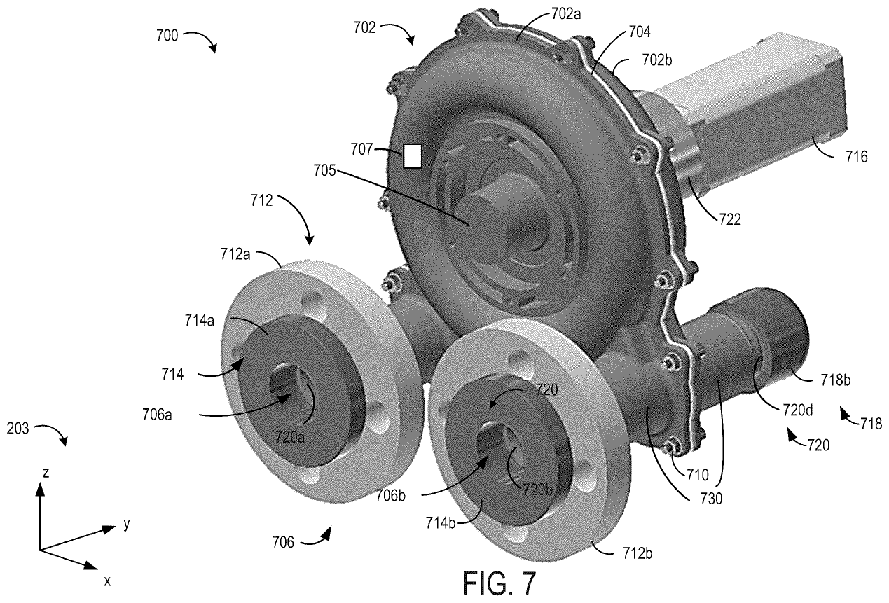

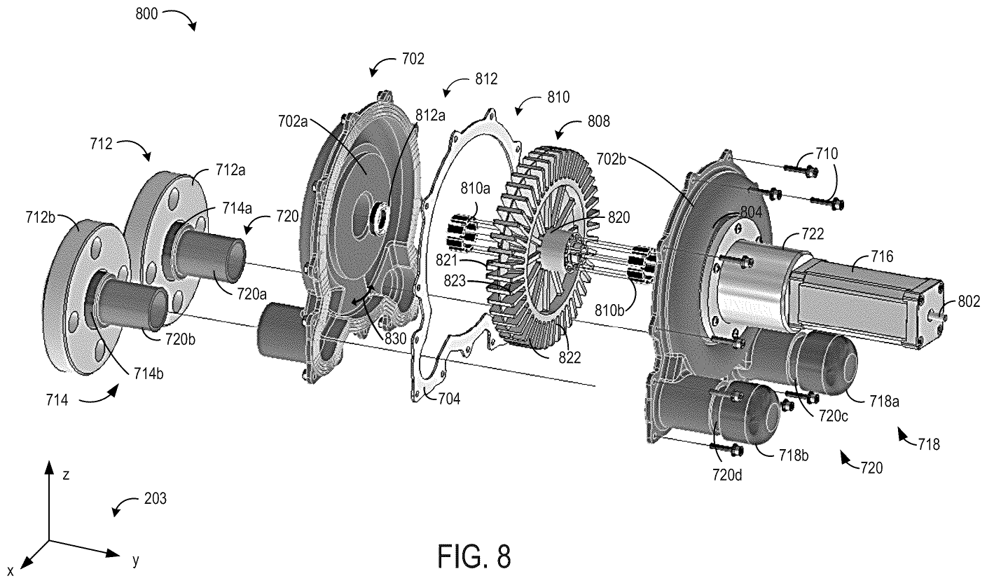

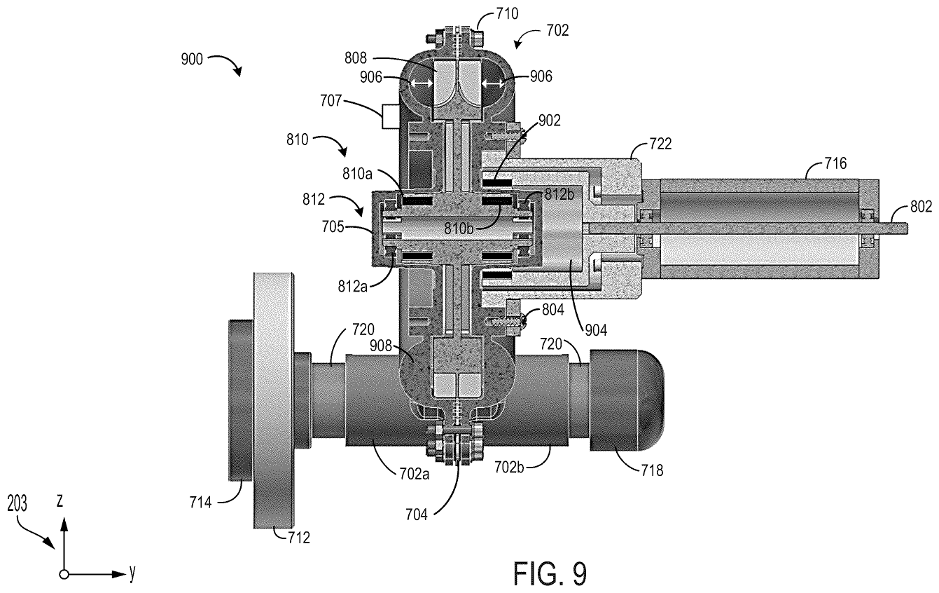

The following description relates to directing hydrogen gas in an electrochemical cell system. In one embodiment, the electrochemical cell system may be a redox flow battery system, such as the redox flow battery system shown in FIG. 1. However, other types of electrochemical cell systems have been considered within the scope of this disclosure. In place of conventional hydrogen gas directing systems, a hydrogen blower assembly, including an impeller coupled to a driver, may be used to propel hydrogen gas throughout the redox flow battery system. The hydrogen blower assembly may be appreciated by cross-sectional views shown in FIGS. 2-3 showing the impeller coupled to a drive shaft. Herein, it is understood that the hydrogen blower may be used to move any relevant gases through passages of an electrochemical cell system. For example, the hydrogen blower assembly by be used to drive air, nitrogen, carbon dioxide, bromine gas, chlorine gas, among others. A cross-sectional view of an alternate embodiment of a hydrogen blower assembly is shown in FIG. 6. A second alternate embodiment of a hydrogen blower assembly is shown in FIG. 7, with an exploded view of the second alternate embodiment in FIG. 8, and a cross-sectional view of the second alternate embodiment in FIG. 9. A motor and drive coupler of the hydrogen blower assembly are shown in cross section in FIG. 4. A method of operating the hydrogen blower assembly is shown in FIG. 5.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺gains an electron to form Fe²⁺during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻↔Fe⁰ −0.44 V (negative electrode) (1)

Fe²⁺↔2Fe³⁺+2e⁻ +0.77 V (positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺is oxidized to Fe³⁺in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors 80 and 82. Rebalancing reactors 80 and 82 may also be referred herein as rebalancing cells.

Conventionally, hydrogen gas may be directed to rebalancing reactors 80 and 82 or other components which demand hydrogen by a multi-component system relying on liquid pumps, venturi injectors, and liquid/gas separators. As described further below, the multi-component system may be replaced by one or more hydrogen blower assemblies 84 and 86. In one example hydrogen blower assemblies 84 and 86 may be positioned so that an impeller of the hydrogen blower assembly is positioned upstream of rebalancing reactors 80 and 82, between one of the gas head spaces 90 and 92 and an inlet of one of rebalancing reactors 80 and 82. Additionally or alternatively, the hydrogen blower assemblies 84 and 86 may be positioned so that the impeller of the hydrogen blower assembly is positioned downstream of one of rebalancing reactors 80 and 82. In this way, an upstream hydrogen blower may drive a positive (e.g., increase in) pressure within one of rebalancing reactors 80 and 82, and a downstream hydrogen blower may drive a negative (e.g., decrease in) pressure.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. The separate dedicated hydrogen gas storage tank may also be coupled to a hydrogen blower assembly. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, and as discussed further below with reference to FIG. 5, controller 88 may energize or de-energize a motor of the hydrogen blower assembly according to a demand for hydrogen gas within the redox flow battery. As another example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

As described above, hydrogen may be moved around a redox flow battery system between a headspace of a multi-chambered electrolyte tank, such as gas head spaces 90 and 92 of FIG. 1. Conventionally, hydrogen may be moved by a system including a combination of venturi injectors, dedicated liquid pumps and liquid/gas separators. However, this system this system includes many possible points of potential mechanical degradation or leakage in addition to the dedicated liquid pumps adding to a parasitic power demand. Instead, hydrogen may be directly driven with a hydrogen blower assembly. A motor of the hydrogen blower assembly may be coupled to a hydrogen blower by a magnetic coupler to allow the motor to indirectly spin the hydrogen blower. In this way an electrified component (e.g., the motor) may be kept separate from the explosive hydrogen gas.

Referring now to FIGS. 2-4, views 200 of a hydrogen blower assembly 202 are shown. FIG. 2 shows a side cross section view 200 of hydrogen blower assembly 202 while FIG. 3 shows a perspective cross section view 300 isolating components of hydrogen blower assembly 202 positioned within a hermetically sealed housing. FIG. 4 shows a perspective cross section view 400 isolating a motor, coupler housing, and drive coupler of the hydrogen blower assembly 202. A set of reference axes 203 is provided for comparison between shown in FIGS. 2-4. Reference axes 203 includes an x-axis, y-axis, and z-axis. The y-axis corresponds to a vertical axis and the x and z axes are each perpendicular to the vertical axis. A top or upwards direction with respect to the hydrogen blower assembly 202 corresponds to a positive direction along the y-axis while bottom or lower direction corresponds to a negative direction along the y-axis as shown in the figures.

Turning now to FIG. 2, hydrogen blower assembly 202 includes an impeller 204 positioned inside a housing 208. In one example, housing 208 may be divided into two pieces; a top housing 208a and a bottom housing 208b as denoted by line 210. As one example, bottom housing 208b may include a perimeter section 211 and a lip 213. The perimeter section 211 may nest inside a perimeter section 217 of top housing 208a. In this way the perimeter section 217 of top housing 208a and perimeter section 211 of bottom housing 208b are in face sharing contact. Additionally, a bottom edge of top housing 208a may rest on and be in face sharing contact with the lip 213. In this way, an amount of surface area between top housing 208a and bottom housing 208b may be increased making a seal between top housing 208a and bottom housing 208b gas tight. Housing 208 and impeller 204 may be formed of plastic or plastic coated metal compatible with long term exposure to hydrogen gas. In one example, housing 208 and impeller 204 may be formed of molded polypropylene.

Housing 208 may include a hydrogen inlet 212 and a hydrogen outlet 214. Hydrogen inlet 212 may be positioned directly below an apex of impeller 204 and perpendicular to hydrogen outlet 214. Hydrogen outlet 214 may therefore be positioned in line with the widest blade lengths of impeller 204 along the x-axis. Housing 208 may include an inlet flange 215 circumferentially surrounding hydrogen inlet 212 and an outlet flange 216 circumferentially surrounding hydrogen outlet 214 to secure hydrogen blower assembly 202 in line with a hydrogen passage of a redox flow battery system (such a redox flow battery system 10 of FIG. 1). In one example, inlet flange 215 may be formed continuously with bottom housing 208b and outlet flange 216 may be formed continuously with top housing 208a.

Top housing 208a may be joined to bottom housing 208b so that hydrogen may be forced through hydrogen inlet 212 and out hydrogen outlet 214 without escaping through an interface of top housing 208a and bottom housing 208b. In an example shown in FIG. 2, top housing 208a may be joined to bottom housing 208b by a plurality of housing fasteners 218 and a gas tight seal may be realized by an o-ring 220 positioned between top housing 208a and bottom housing 208b. In another example, top housing 208a may be fused to bottom housing 208b by a method appropriate for fusing plastic components, such as but not limited to hot-plate welding, friction stir welding, laser welding, ultrasonic welding, and gluing.

Impeller 204 may be suspended within housing 208. In this way, liquid and debris accumulation on suspended bearings 228 may be prevented. Said another way, impeller 204 may be spaced away from and may not be in physical contact with inner faces of housing 208. Impeller 204 may be an opened, closed, or semi-closed impeller.

A stem 221 of impeller 204 may be the portion of impeller 204 inside dashed box 222. Stem 221 of impeller 204 may include a balancing hole 224 positioned along a rotational axis 226 of impeller 204. Balancing hole 224 may be a hollow tube extending through the stem of impeller 204. A radial width of balancing hole 224 along the x-axis may be less than a width of stem 221. In this way, axial thrust of the spinning impeller may be mitigated.

Suspended bearings 228 may be positioned around a top portion 229 of stem 221. An inner surface of suspended bearings 228 may be in direct face sharing contact with the top portion 229 of stem 221 while outer surfaces of suspended bearings 228 may be in direct face sharing contact with an inner surface 209 of top housing 208a. Further, suspended bearings 228 may be secured to the inner surface of top housing 208a by press-fit, snap-fit, or by gluing. In this way, suspended bearing may allow free and high speed (e.g., high rotations per minute [rpm]) rotation of impeller 204 within housing 208. Suspended bearings 228 may be exposed to a hydrogen atmosphere and may therefore be formed of a chemically compatible material such as ceramic. Suspended bearings 228 may include a first suspended bearing 228a and a second suspended bearing 228b spaced along the top portion 229 of stem 221. However, greater or fewer suspended bearings have been considered within the scope of this disclosure. Stem 221 may also include inner magnetic coupling 230 positioned below suspended bearings 228. In one example, inner magnetic coupling 230 may be shaped as a rectangular prism and five of the six faces of inner magnetic coupling 230 may be in face sharing contact with stem 221.

A drive coupler 234 may be positioned around a top portion of top housing 208a. Drive coupler 234 may surround a portion of top housing 208a which circumferentially surrounds stem 221. Drive coupler 234 may include outer magnetic coupling 232. Outer magnetic coupling 232 may be positioned within drive coupler 234 to align vertically (e.g., along the y-axis) with inner magnetic coupling 230 positioned on stem 221. Inner magnetic coupling 230 and outer magnetic coupling 232 may magnetically couple drive coupler 234 to stem 221 and may not experience relative motion during operation of hydrogen blower assembly 202.

A coupler housing 236 may be positioned to circumferentially surround drive coupler 234. Coupler housing 236 may be coupled to top housing 208a by a retaining ring 238. Retaining ring 238 may be held in face sharing contact with both top housing 208a and a lip 241 of coupler housing 236 by coupler fasteners 240. A top of coupler housing 236 may be in face sharing contact with motor 242. A motor 242 may be coupled to coupler housing 236 by motor fasteners 244. In one example, motor 242 may be a brushless DC motor. Motor 242 may include a servo optical encoder or hall effect sensor configured to sense a speed (e.g., rpm) of motor 242 and may be communicatively coupled to a controller of the motor. In this way, the speed of motor 242, and thereby a flow rate of hydrogen gas, may be precisely controlled.

A shaft 246 of motor 242 may be coupled to a top of drive coupler 234. When motor 242 is energized, shaft 246 may spin around rotational axis 226 causing drive coupler 234 to also rotate around rotational axis 226. Rotation of drive coupler 234 may cause outer magnetic coupling 232 to drive rotation of impeller 204 via magnetic forces of outer magnetic coupling 232 on inner magnetic coupling 230. By action of magnetic forces, impeller 204 may be driven while also being hermetically sealed from any energized components. In this way, probability of reactions between sparks from electrical equipment and hydrogen gas may be minimized.

In an alternate embodiment, a stationary magnetic field generator may be coupled to top housing 208a in place of drive coupler 234, coupler housing 236, and motor 242. The stationary magnetic field generator may generate a magnetic field driving motion of impeller 204 by interacting with inner magnetic coupling 230. A driver of hydrogen blower assembly 202 (e.g., either motor 242 or the stationary magnetic field generator) may be actuated by a controller of the redox flow battery system, such a controller 88 of FIG. 1. Control of hydrogen blower assembly 202 may be discussed further below with respect to FIG. 5.

Hydrogen blower assembly 202 may further include at least one sensor 248. The at least one sensor 248 is shown in FIG. 2 positioned on an outer surface of top housing 208a, however other positions of at least one sensor 248 such as an outer surface of motor 242, and/or in close proximity to the hydrogen blower assembly have been considered within the scope of this disclosure. Further sensor 248 may be one or more sensors, each sensor positioned on a different area of hydrogen blower assembly 202. The at least one sensor 248 may be communicatively coupled to the controller so as to communicate sensed values to a controller, such as controller 88 of FIG. 1. In one embodiment, at least one sensor 248 may be a vibration sensor. In this way excess vibrations may be sensed if impeller 204 becomes uncoupled from suspended bearings 228 and begins to wobble. Additionally or alternatively, at least one sensor 248 may be temperature sensor or a hydrogen gas sensor. The temperature sensor may detect if hydrogen blower assembly is operating outside of a desired temperature range. The hydrogen gas sensor may be positioned outside of and in close proximity to housing 208 to detect if any hydrogen gas has escaped the hermetic seal.

Turning now to FIG. 3, a perspective cross section view 300 of hydrogen blower assembly 202 is shown. Motor 242, coupler housing 236, and drive coupler 234 are omitted from view 300 for clarity. Perspective cross section view 300 may show how components of hydrogen blower assembly 202 contacting hydrogen are hermetically sealed away from energized components of hydrogen blower assembly 202 (e.g., motor 242). In this way a probability of hydrogen blower assembly 202 igniting hydrogen gas may be decreased without demanding bulky explosion proof wiring, thereby decreasing the footprint of the hydrogen blower assembly.

Hydrogen gas may enter hydrogen blower assembly 202 via hydrogen inlet 212 following first arrow 302. Hydrogen blower assembly 202 may be hermetically sealed to a first path of hydrogen flow fluidly connecting a source of the hydrogen gas to hydrogen blower assembly 202 via a seal of inlet flange 215. The source of hydrogen gas may be at least one hydrogen gas storage container such as a gas headspace of an electrolyte tank (e.g., head spaces 90 and 92 of FIG. 1) or a supplementary hydrogen gas tank. Hydrogen gas may be forced out of hydrogen blower assembly 202 through hydrogen outlet 214 by force imparted by impeller 204 in a direction indicated by second arrow 304. Hydrogen outlet 214 may be sealed to a second path of hydrogen flow via outlet flange 216. The second path of hydrogen flow may fluidly connect an output of hydrogen blower assembly 202 to a component of a redox flow battery system configured to receive hydrogen gas. In one example the component of the redox flow battery system demanding hydrogen may be a rebalancing reactor such rebalancing reactors 80 and 82 of FIG. 1.

Perspective cross section view 300 may also show how impeller 204 is suspended within housing 208. Impeller 204 may be spaced away from an inner surface of housing 208. Impeller 204 may be suspended within housing 208 by contact of stem 221 with suspended bearings 228 which are in face sharing contact with both stem 221 and housing 208. In this way liquid and/or debris which may enter hydrogen blower assembly 202 along with hydrogen gas may be also be expelled from hydrogen blower assembly 202 without becoming trapped between an outer surface of impeller 204 and the inner surface of housing 208.

Turning to FIG. 6, an alternate embodiment of a hydrogen blower assembly 602 is shown in a cross sectional view 600. Hydrogen blower assembly 602 may include inner magnetic coupling 230 of FIGS. 2-3 and other components that are discussed with respect to FIGS. 2-3. Such components are labeled similarly and will not be reintroduced. Additionally, hydrogen blower assembly may include drive coupler 234, coupler housing 236, and motor 242 as described above with respect to FIG. 2 but are omitted from view 600 for clarity.

Hydrogen blower assembly 602 may include a housing 608 and an impeller 604. Housing 608 may include a top housing 608a and a bottom housing 608b. Top housing 608a and bottom housing 608b may be joined together, e.g., may interface with one another, so that top housing 608a is hermetically sealed to bottom housing 608b as described above with respect to housing 208 of FIG. 2.

Bottom housing 608b may include a hydrogen inlet 612. As described above with respect to FIG. 2, hydrogen inlet 612 may be positioned directly below an apex of impeller 604. A coupler 615 may couple a hydrogen inlet pipe 614 to hydrogen inlet 612. In one example, an end of hydrogen inlet pipe 614 proximal to bottom housing 608b may be in face sharing contact with a bottom edge of bottom housing 608b. Outer coupler 615 may circumferentially surround a sleeve portion 616a of flange 616 and an upper portion of a radially inner surface (e.g., with respect to the x-axis) of flange 616 may in turn circumferentially surround a lower (e.g., along the y-axis) portion of bottom housing 608b. Said another way, the sleeve portion 616a of flange 616 may be in face sharing contact with both the lower portion of bottom housing 608b and with outer coupler 615, with the sleeve portion 616a of flange 616 arranged between the lower portion of bottom housing 608b and outer coupler 615. In this way, hydrogen inlet 612 may be fluidly coupled and hermetically sealed with respect to hydrogen inlet pipe 614. In some examples a hydrogen outlet pipe may be coupled to housing 608 via an outer coupler and a flange in a manner similar to hydrogen inlet pipe 614.

Additionally, bottom housing 608b may include a water trap 620. Water trap 620 may circumferentially enclose a lower portion (e.g., along the y-axis) of impeller 604. Water trap 620 may include three sides. A first, outer side (e.g., a side furthest away from rotational axis 226) and a second, lower side may each be formed by bottom housing 608b. A portion of a third, inner side (e.g., a side closest to rotational axis 226) of water trap 620 may be formed at least partially by an outer surface of impeller 604. In some examples, the inner side of water trap 620 may also be at least partially formed by bottom housing 608b. In some examples, impeller 604 may be positioned with respect to water trap 620 so that the outer surface of impeller 604 may be undercut by bottom housing 608b. Impeller 604 may be positioned so that water trap 620 does not interfere with free and fast rotation of impeller 604.

In an example where hydrogen gas or an air/hydrogen gas mixture passing through hydrogen blower assembly 602 is humid, water may condense inside housing 608 and may collect inside water trap 620. Water collecting inside water trap 620 may form a seal, thereby preventing air bypass from an outlet of hydrogen blower assembly 602 to hydrogen inlet 612. In this way, an output pressure of hydrogen blower assembly 602 may be increased without demanding high precision machining and assembly of components.

Impeller 604 may include a stem 621. Stem 621 may include suspended bearings 628 and inner magnetic coupling 230. Suspended bearings 628 may be formed of a chemically resistant material and fit into housing 608, similar to suspended bearings 228 of FIG. 2. Stem 621 may circumferentially surround a flared portion 624 of top housing 608a. Flared portion 624 may be thermally formed to be in face sharing contact with an inner surface of stem 621. An upper bearing 628a of suspended bearings 628 may be positioned so that an inner side of upper bearing 628a is in face sharing contact with stem 621 and an outer side of upper bearing 628a is in face sharing contact with top housing 608a. A lower bearing 628b of suspended bearings 628 may be positioned so that an inner surface of lower bearing 628b is in face sharing contact with flared portion 624 and an outer portion is in face sharing contact with stem 621. In this way, impeller 604 and suspended bearings 628 may be retained without demanding fasteners. Securing impeller 604 and suspended bearings 628 without fasteners may reduce a probability of fasteners of impeller 604 becoming unseated by vibrations without demanding reliance on high precision fasteners.

Turning to FIG. 7, a second alternate embodiment of a hydrogen blower is shown. The second alternate embodiment may be configured as a regenerative blower. A hydrogen blower assembly 700 may include a housing 702, a set of hydrogen inlet/outlets 706, a motor 716, and a coupler housing 722. The housing 702 may be symmetrical in the x-z plane and in the x-y plane as defined in reference axes 203, so that the hydrogen inlet/outlets 706 may both be on the same side of the housing 702 (e.g. both in the negative y-direction from the housing 702 in FIG. 7). The housing 702 may have a hollow circular body with tangent circular inlet/outlet ports 730, and a hollow circular protruding portion 705 on both sides from the center of the circular body. Housing 702 may include two pieces; a first housing piece 702a and a second housing piece 702b, wherein the housing 702 is divided axially into the first housing piece 702a and second housing piece 702b. The shape of the first housing piece 702a and second housing piece 702b may each include two inlet/outlet ports 730. The inlet/outlet ports 730 may be distributed radially around the circular portion of the housing pieces 702a and 702b such that the inlet/outlet ports are no more than 180 degrees apart and a length of a stripper section (e.g. the distance between the inlet/outlet ports 730 along housing 702, as shown in FIG. 8 as stripper section 830) may be between 3 mm and 200 mm. In other words, the inlet/outlet ports 730 may be arranged on a same radial side of the housing 702. The first housing piece 702a and the second housing piece 702b may be made of plastic or metal including polypropylene, polyethylene (including high density polyethylene and ultra-high molecular weight polyethylene), polyetheretherketone, polytetrafluoroethylene (PTFE), acrylonitrile butadiene styrene, nylon, titanium, steel, aluminum, and the like. The first housing piece 702a and second housing piece 702b may also be a plastic material, such as the examples given, with glass or talc-filler additives. The first housing piece 702a and second housing piece 702b may be substantially the same such that the first housing piece 702a and the second housing piece 702b may be interchangeable. In this way, manufacturing complexity may be reduced compared to other embodiments with two non-identical housing components, and a cost of manufacturing may be reduced due to a decreased number of unique molds needed to make parts.

The housing 702 may be hermetically sealed such that gas may enter or exit an interior of the housing through the inlet/outlets 706 and may not enter or exit the interior of the housing through other avenues. In some examples, first housing piece 702a may be fastened to second housing piece 702b by fasteners 710, and the housing 702 may be sealed by a gasket 704 at the interface between the housing pieces 702a and 702b. The gasket material may be fluoroelastomer, polychloroprene, cork, polyurethane, ethylene propylene diene monomer, PTFE, and the like, including any variants of gasket materials that have been altered to have a different structure (e.g. porous structure). The gasket may prevent the movement of gases (e.g. hydrogen, air, water vapor, nitrogen, carbon dioxide, bromine, chlorine, etc.) across the interface between the housing pieces 702a and 702b such that gas may enter and exit the housing 702 through inlet/outlets 706 and not through the interface between housing pieces 702a and 702b. Alternative sealing methods may be used, such as by welding the first housing piece 702a and second housing piece 702b, or by applying an adhesive (e.g. glue) between the housing pieces 702a and 702b such that the adhesive bonds the housing pieces 702a and 702b together, chemically and/or physically. Additionally, one or more sensors 707 may be coupled to and in face sharing contact with an outer surface of housing 702. One or more sensors 707 may be configured to one or more sensors 248 as described above.

The hydrogen inlet/outlets 706 include hydrogen inlet/outlet ports 730, hydrogen inlet/outlet pipes 720 (better seen in FIG. 8 and FIG. 9), flanges 714, and outer couplers 712. Each of the hydrogen inlet/outlet pipes 720 (e.g. 720a, 720b) may be substantially the same and may be coupled to one of the hydrogen inlet/outlet ports 730 such that the inner surfaces of the hydrogen inlet/outlet ports 730 may be in face sharing contact with the outer surface of the hydrogen inlet/outlet pipes 720, wherein the hydrogen inlet/outlet ports 730 circumferentially surround the hydrogen inlet/outlet pipes 720. Each of the flanges 714 (e.g. a first flange 714a, and a second flange 714b) may be substantially the same. In some examples, flanges 714 may be welded to the hydrogen inlet/outlet pipes 720 to direct flow. For example, flange 714a may be welded to the inlet/outlet pipe 720a Similarly, flange 714b may be welded to inlet/outlet pipe 720b. In other examples, flanges 714 may be male or female quick-connect ports. Outer couplers 712 may be coupled to the flanges 714 such that the outer couplers 712 may circumferentially surround a portion the flanges 714. For example, outer coupler 712a may be coupled to flange 714a Similarly, outer coupler 712b may be coupled to flange 714b. The outer coupler 712a and the outer coupler 712b may also be substantially the same. As such, each of the hydrogen inlet/outlets 706 may comprise substantially the same subparts and may be used interchangeably (e.g. inlet/outlet ports, inlet/outlet pipes, flanges, outer couplers).

Because each of a first hydrogen inlet/outlet 706a and second hydrogen inlet/outlet 706b consist of substantially the same subparts and assembly, each may function as an inlet or an outlet depending on the desired configuration of the hydrogen blower assembly 700 within a system (e.g. flow battery system 10 of FIG. 1). For example, hydrogen inlet/outlet 706a may be an inlet and hydrogen inlet/outlet 706b may be an outlet. In another example, hydrogen inlet/outlet 706a may be an outlet and hydrogen inlet/outlet 706b may be an inlet. In other examples, hydrogen inlet/outlet 706a and/or hydrogen inlet/outlet 706b may be coupled to housing piece 702b instead of 702a (with orientations as shown in FIG. 7).

In some examples, the hydrogen inlet/outlets 706 may be on the opposite side of the housing 702 from the motor 716 (e.g. the hydrogen inlet/outlets 706 in a negative y-direction from the housing 702 and the motor 716 in a positive y-direction from the housing 702, or vice versa). In other examples, the hydrogen inlet/outlets 706 may be on the same side of the housing 702 as the motor 716 (e.g. the hydrogen inlet/outlets 706 and the motor 716 both in a positive y-direction from the housing 702). In some examples, the inlet/outlet ports 730 that are not part of hydrogen inlet/outlets 706 (e.g. the inlet/outlet ports 730 of housing piece 702b in FIG. 7) may each be plugged by a cap 718 (e.g. cap 718a and cap 718b which are shown in FIG. 8), wherein the caps 718 prevent undesirable gas flow out of the housing 702 through locations other than the hydrogen outlet (e.g. inlet/outlet 706a or 706b). In other examples, the caps 718 may be omitted and the inlet/outlet pipes 720c and 720d may be coupled to flanges or quick-connect ports configured to fluidly connect hydrogen blower assembly 700 to an adjacent hydrogen blower. In this way inlet/outlet ports 730 may act as a pass-through wherein gasses may be allowed to flow to the adjacent hydrogen blower in parallel or in series. In this way, the overall structure of the hydrogen blower assembly 700 may be flexible so as to fit in multiple spatial configurations, including in parallel or in series with other hydrogen blowers, depending on the requirements of the system in which it may belong (e.g. flow battery system 10 of FIG. 1).

Turning to FIG. 8, an exploded view 800 of hydrogen blower assembly 700 shows several elements as described in regards to FIG. 7, which are labeled similarly and will not be reintroduced. In addition, FIG. 8 shows components not seen in FIG. 7, including an impeller 808, a plurality of magnets 810, suspended bearings 812, and a shaft 802.

As seen in exploded view 800, the impeller 808 may be enclosed in the circular portion of the hydrogen blower assembly 700 by the housing pieces 702a and 702b, which may be hermetically sealed by gasket 704 and joined by fasteners 710 Similar to the housing 702 material, the impeller 808 material may be plastic or metal including polypropylene, polyethylene (including high density polyethylene and ultra high molecular weight polyethylene), polyetheretherketone, polytetrafluoroethylene (PTFE), acrylonitrile butadiene styrene, nylon, titanium, steel, aluminum, and the like. The impeller 808 may also be a plastic material, such as the examples given, with glass or talc-filler additives. In some embodiments, the impeller 808 may be made of the same material as the housing 702. In other embodiments, the impeller 808 may be made of a different material than the housing 702. A shape of the impeller 808 may consist of a circular hollow stem portion 820 protruding from the plane in which a plurality of blades 822 may protrude radially from the stem portion 820 (e.g. x-z plane defined by reference axis 203). The plurality of blades 822 may be arranged at blade angles 823 relative to the plane in which the blades are radially arranged. As one example, the blade angles 823 may be between −45° and 45°. The plurality of blades 822 may each have a same blade angle 823, or the plurality of blades 822 may have blade angles 823 of different values within the range of −45° to 45°. The blades may be arranged such that the space between the blades 821 at the outer circumference of the impeller may be between 1 mm and 20 mm. The impeller may be radially symmetrical across the x-z plane, such that a stem portion 820 protrudes from both sides of the impeller (e.g. towards both housing pieces 702a and 702b). In other words, the impeller 808 may be symmetrical such that the stem portion 820 extends in both the positive and negative y-direction from the plurality of blades 822. Because impeller 808 may be symmetrical and plurality of blades 822 may be formed without undercuts, impeller 808 may be formed by injection molding, in one example. Impeller 808 may also be altered in post-machining or modification for balancing to ensure rotational stability.

The impeller 808 may be suspended within housing 702 such that the impeller 808 may be spaced apart from inner faces of housing pieces 702a and 702b by between 0.1 mm and 3 mm. The impeller 808 may be coupled to the housing 702 by bearings 812. The bearings 812 each may be shaped like a ring, wherein the outer diameter of the ring-shaped bearings 812 may be less than the inner diameter of the hollow circular protruding portion 705 of housing 702. Bearings 812 may come in to contact with hydrogen and may therefore be formed of a chemically compatible material with hydrogen such as ceramic, including but not limited to zirconia oxide, silicon nitride, PTFE, PEEK, and glass. Bearings 812 may be secured to an inner surface of the hollow circular protruding portions 705 of housing pieces 702a and/or 702b by press-fit, snap-fit, or adhesive (e.g. glue). In some embodiments, there may be two bearings 812a and 812b. For example, there may be a bearing 812a attached to housing piece 702a and a bearing 812b attached to housing piece 702b. Bearings 812a and 812b may be of substantially the same shape and size. In other examples, bearings 812a and 812b may be different sizes and shapes, relative to one another. An inner surface of bearings 812 may be in direct face sharing contact with the stem portion 820 of impeller 808 while an outer surface of bearings 812 may be in face sharing contact with housing pieces 702a and 702b. In this way, bearing 812 may allow high rotational speed of impeller 808 within housing 702. During operation of hydrogen blower assembly 700 (e.g., when impeller 808 is rotating), an axial load may be placed upon the center of rotation of the impeller 808 via bearings 812, such that the bearings 812 may stabilize the impeller 808 while impeller 808 rotates with high rotational speed.

As described previously, hydrogen inlet/outlets 706 may be on the same side of the housing 702 (e.g. coupled to housing piece 702a). In this way, hydrogen gas may be directed axially towards the impeller 808 through one of hydrogen inlet/outlets 706, and then the hydrogen gas may change direction to flow radially with the rotational speed of the impeller 808. Because the change of direction of the gas occurs in the stationary housing away from the impeller 808 (e.g. at the point where the hydrogen inlet/outlet ports 730 meet the adjacent portion of the housing 702), cross-axial loading may be placed on the impeller 808, without axial loading being placed on impeller 808 offset from the center of impeller 808 rotation. In this way, hydrogen blower assembly 700 may be more stable and functional than other turbomachinery wherein the directional flow of gas places an axial load offset from the center rotation. An blower assembly having axial load may demand a heavier and stiffer impeller than an impeller of a blower assembly without axial loading. Further limitations on rotational speed to prevent vibration, deflection, and damage may be present in an blower assembly including axial load which are not present in a blower assembly (e.g., hydrogen blower assembly 700) without axial loading.

A plurality of magnets 810 may be positioned circumferentially around at least one end of the stem portion 820 of impeller 808. The plurality of magnets 810 may be installed on the impeller 808 by welding (e.g. plastic welding), gluing, over-molding, and the like. In some examples, because impeller 808 may be radially symmetric, there may be two sets of magnets 810, wherein a first set of magnets 810a may be positioned around a first end of the stem portion 820 of impeller 808, and a second set of magnets 810b may be positioned around a second end of the stem portion 820, the first end opposite the second end across the y-axis. With magnets 810 on each end of stem portion 820, impeller 808 may be symmetrical including the addition of magnets 810 such that the impeller 808 may be oriented in different directions (e.g. with a first end of the impeller 808 being coupled to either housing piece 702a or 702b). In other words, impeller 808 may be oriented relative to other parts as shown in FIG. 8, or impeller 808 may be oriented differently by rotating impeller 808 around the z-axis by 180 degrees, or a multiple thereof. Including a set of magnets 810a and 810b on both ends of the stem portion 820 of impeller 808 may stabilize the hydrogen blower assembly 700 by concentrating more mass towards the center of rotation of the impeller 808. In some embodiments, a first set of magnets (e.g., 810a) may be couple to motor 716 and a second set of magnets (e.g., 810b) may be used to provide speed information to a magnetic speed sensor (e.g., one of one or more sensors 707). Additionally, an impeller 808 with symmetrically placed sets of magnets 810a and 810b may allow for axial-joining of two hydrogen blowers (e.g. hydrogen blower assembly 700), wherein the two hydrogen blowers may share a single common motor (e.g. motor 716). In this way, a power demand for operating two hydrogen blowers may be decreased. In some examples, the two hydrogen blowers may be decreased. In some examples, the two hydrogen blowers may be arranged in parallel or in series as described above.

In other examples, a single set of magnets 810b may be positioned around an end of the stem portion 820 adjacent to the motor 716. In some embodiments, the plurality of magnets 810 may be arranged such that each magnet in the set of magnets 810a may oriented with a common polarity (e.g. all magnets in the set of magnets 810a may have a north pole oriented towards the axis of impeller 808 rotation), and each magnet in the set of magnets 810b may be oriented with a common polarity. In other embodiments, the sets of magnets 810a and 810b may be arranged with alternating polarity such that each magnet may have an opposite polarity compared to neighboring magnets.

Motor 716 may be positioned on either side of housing 702 (e.g. towards the positive or negative y-direction form the housing 702). Motor 716 may be coupled to the housing 702 by coupler housing 722. In other words, a portion of coupler housing may be in face sharing contact with motor 716, and a second portion of coupler housing 722 may also be in face sharing contact with housing piece 702b. In other examples, coupler housing 722 may be in face sharing contact with housing piece 702a (rather than housing piece 702b) such that the motor 716 may be adjacent to housing piece 702a and inlet/outlets 706. Coupler housing 722 may be secured to housing 702 by fasteners 804.

Turning to FIG. 9, a cross section view 900 of hydrogen blower assembly 700, showing several of the same parts from FIG. 7 and FIG. 8, which are labeled accordingly and will not be reintroduced. Additionally, FIG. 9 includes a drive coupler 904 and an outer magnetic coupling 902. Drive coupler 904 may circumferentially surround a hollow circular protruding portion 705 of housing 702 which surrounds the first or second end of the stem portion 820 of impeller 808. Coupler housing 722 may circumferentially surround the drive coupler 904. A shaft 802 of motor 716 may couple to drive coupler 904. The plurality of magnets of the outer magnetic coupling 902 may be arranged circumferentially around the outer surface of drive coupler 904. The plurality of magnets of the outer magnetic coupling 902 may be oriented with the same polarity. In other examples, the plurality of magnets of the outer magnetic coupling 902 may be arranged with alternating polarity such that each magnet is adjacent to two other magnets (e.g. to the left and right) of opposite polarity. The plurality of magnets of the outer magnetic coupling 902 may align (e.g. along the y-axis) with the set of magnets 810b such that the set of magnets 810b acts as an inner magnetic coupling. A number of magnets included in the set of magnets 810b may match a number of magnets included in the outer magnetic coupling 902. Alternatively, because impeller 808 may be symmetric, impeller 808 may be flipped such that the set of magnets 810a aligns with a matching number of plurality of magnets of the outer magnetic coupling 902 (e.g. at the same lateral location along the y-axis), and therefore the set of magnets 810a may act as the inner magnetic coupling. In this way, the hydrogen blower assembly 700 may use a magnetically coupled drive to rotate the impeller 808, however other methods of rotating the impeller may be employed (e.g. directly driving the impeller 808 with a surrounding sealing surface to prevent hydrogen gas leaks) without departing from the scope of the present disclosure.

In some examples, impeller 808 may not include magnets and motor 716 may be directly, physically coupled to impeller 808. In such an example, a sealing surface may be present at an interface of the coupler and housing 208 to prevent leaks of gas outside the housing at the interface.

Further, as shown in cross section view, a distance between impeller 808 and an inner wall of housing 208 is shown by arrow 906. The distance shown by arrow 906 corresponds to a diameter of a vortex. The vortex may be the spinning of gas molecules of the pumped gas (e.g., hydrogen) in a regenerative section of the housing 208 (e.g., the section that is not the stripper section. The distance of arrow 906, corresponding to the diameter of the vortex may be in a range of 3 mm-100 mm. Additionally, a cross section 908 of the stripper section of housing 208 is shown. A distance between impeller 808 and an internal surface of housing 208 may be smaller than the diameter of the vortex. Further, the distance between impeller 808 and internal surface of housing in stripper cross section 908 may be a minimal distance for free rotation of impeller 808 within housing 208. In this way, the gas molecule pressure generated by the vortices in the regenerative section of the housing may be forced out of the outlet when meeting the stripper section.

Turning now to FIG. 4, a perspective cross section view 400 of a hydrogen blower assembly showing motor 242, coupler housing 236 and drive coupler 234. Housing 208 and components enclosed within housing 208 are omitted from perspective cross section view 400 for clarity.

Drive coupler 234 may include outer magnetic coupling 232. As shown in perspective cross section view 400, outer magnetic coupling 232 may include a plurality of first magnets 402 and a plurality of second magnets 404. The plurality of first magnets 402 may be oriented with poles in opposite directions from poles of the plurality of second magnets 404. As one example a north pole of the plurality of first magnets 402 may be oriented towards an inner surface of drive coupler 234 (e.g., toward a positive direction of the x-axis) while a north pole of the plurality of second magnets 404 may be oriented towards an outer surface of drive coupler 234 (e.g., toward a negative direction of the x-axis).

The plurality of first magnets 402 and the plurality of second magnets 404 may be similarly sized and arranged in alternating fashion around a lower circumference of drive coupler 234. For example, a magnet of the plurality of first magnets 402 may positioned so that two neighboring magnets (e.g., to the left and to the right) along the lower circumference of drive coupler 234 are both magnets of the plurality of second magnets 404. Although not shown, inner magnetic coupling 230 may similarly include a plurality of first magnets and a plurality of oppositely oriented second magnets positioned in alternating fashion around a circumference of stem 221. A number of magnets included in inner magnetic coupling 230 may match a number of magnets included in outer magnetic coupling 232. As one example inner magnetic coupling 230 and outer magnetic coupling 232 may each include 8 magnets.

Turning now to FIG. 5, a method for operating an electrochemical cell system, such as a redox flow battery system (e.g., redox flow battery system 10 of FIG. 1) including one or more hydrogen blower assemblies, such as hydrogen blower assembly 202 described above with respect to FIGS. 2-4 and 6-9 is shown. One of the one or more hydrogen blower assemblies may be positioned upstream of a component demanding hydrogen gas. Additionally or alternatively, one of the one or more hydrogen blower assemblies may be positioned downstream of the component demanding hydrogen gas. Additionally, the one or more hydrogen blower assemblies may be positioned upstream of at least one hydrogen storage container. The at least one hydrogen storage container may be a gas head space of a multi-chamber electrolyte storage tank (such as multi-chambered electrolyte storage tank 110 of FIG. 1). Additionally or alternatively, the at least one hydrogen storage container may be a supplementary hydrogen gas tank. During normal operation of the redox flow battery system, a change in hydrogen gas pressure may not be demanded by components of the redox flow battery system, such as rebalancing reactors, and the one or more hydrogen blower assemblies may remain un-energized (e.g., off) to conserve energy. Method 500 may be carried out via the controller 88 of FIG. 1, and may be stored as executable instructions at a non-transitory storage medium (e.g., memory) communicably coupled to controller 88. Method 500 may be executed upon activation of the redox flow battery system. For example, electrolyte flow may be driven and controlled by one or more pumps and valves and the battery system may be operating in a charging, discharging, or idling mode.

At 502, method 500 determines if there is a demand for a change in hydrogen gas pressure. A change in hydrogen gas pressure may be demanded when a component of the redox flow battery system demands additional hydrogen gas. As one example, the component may be one or more rebalancing reactors (such as rebalancing reactors 80 and/or 82 of FIG. 1). The demand for hydrogen may be determined based on signals from sensors of the redox flow battery system. For example, a pH sensor of the redox flow battery system may report a pH of an electrolyte outside of a target range which may indicate a demand for increased hydrogen to flow to one or more of the rebalancing reactors or to electrode compartments. If method 500 determines that no change in hydrogen gas pressure is demanded (NO), method 500 may continue to 504 to maintain normal operating conditions and the hydrogen blower assembly may remain de-energized. Method 500 then ends.

If a demand for a change in hydrogen pressure is demanded (YES), method 500 proceeds to 506 and includes energizing one of the one or more hydrogen blower assemblies. Hydrogen pressure may be increased by energizing a hydrogen blower assembly positioned upstream of the component while hydrogen pressure may be decreased by energizing a hydrogen blower assembly positioned downstream of the component. Energizing the hydrogen blower assembly may include adjusting an operating condition of the hydrogen blower assembly by providing power to a driver of one of the one or more hydrogen blower assemblies, causing rotation of outer coupling magnets which may therefore exert forces on inner coupling magnets, thereby resulting in rotation of an impeller of the hydrogen blower assembly. In one embodiment, the driver may be a DC brushless motor. In an alternate embodiment, the driver may be a stationary magnetic field generator which may exert the magnetic forces causing the inner coupling magnets to rotate the impeller of the hydrogen blower. The energized driver may be positioned outside a hermetic seal of the housing of the hydrogen blower assembly.

At 508, method 500 determines if a hydrogen flow rate is within a target flow rate range. In one example, the hydrogen flow rate may be known based on a speed of the driver (e.g., speed of the DC brushless motor). In alternate examples, the hydrogen flow rate may be determined by a flow meter positioned downstream of the hydrogen blower assembly. If the hydrogen flow rate is within the target flow rate range (YES), method 500 proceeds to 510 and includes maintaining a power to the driver. Method 500 then ends.

If the hydrogen flow rate is not within the target flow rate range (NO), method 500 proceeds to 512 and includes modifying a power to the driver. Modifying the power to the driver may in turn vary a speed of the impeller to change the hydrogen gas flow rate. In one example, if the hydrogen flow rate is below the target flow rate range, the power to the driver may be increased. In another example, if the hydrogen flow is above a target flow rate range the power to the driver may be decreased. In this way, a power demand of the hydrogen blower assembly may be proportional to the hydrogen flow rate demand of the redox flow battery system and an energy used for directing hydrogen flow may be reduced. Additionally or alternatively, a flow controller (such as mass flow controller) may be positioned downstream of the hydrogen blower assembly. Hydrogen gas flowing through the mass flow controller may be maintained at a hydrogen flow rate at or below a threshold level without adjusting a power to the driver.

At 514, method 500 determines if sensors or inputs of the one or more of the hydrogen blower assemblies is reporting within a target range. In one example, sensors (such as one or more sensors 248 of FIG. 2-3) may be coupled to an external surface of a housing or driver of the one or more hydrogen blower assemblies. In one example, a sensor may be a vibration sensor, and a vibration level outside of the target range may indicate that an impeller of the hydrogen blower assembly is unseated. As an alternate example, a change in vibrational level over time outside of the target range may indicate the impeller of the hydrogen blower assembly is unseated. Additionally or alternatively, sensors may also include a temperature sensor and/or a hydrogen gas sensor. A target temperature range for operation of the hydrogen flow battery may include temperatures equal to or less than 70° C., as a non-limiting example. The controller may also monitor an input of the one or more hydrogen blower assemblies. In one example, the input may be an electrical current demand of the driver of the one or more hydrogen blower assemblies. The electrical current demand outside of a target range may indicate degradation of the one or more hydrogen blower assemblies. As a further example, change in electrical current demand over time outside of a target range may also indicated degradation of the one or more hydrogen blower assemblies.

If at 514, it is determined that a sensor is reporting a value outside of the target range (NO), method 500 proceeds to 516 and includes generating a notification. The notification may be a visual or audio notification such as a flashing light or a beep. In some examples, method 500 may also include automatically de-energizing the hydrogen blower assembly at 517 in addition to generating the notification. Additionally or alternatively, at 519, method 500 includes adjusting an operating condition of the electrochemical cell system in addition to generating the notification. Adjusting the operating condition may include, for example, switching from a charging mode to an idle mode. As an alternate example, adjusting the operating condition may include de-energizing other components of the electrochemical cell system, such as pumps or heaters. Method 500 then ends.

If at 514, it is determined that all sensors and inputs of the hydrogen blower assembly are reporting within the target range (YES), method 500 proceeds to 518 and includes maintaining energy to the hydrogen blower assembly. Method 500 then ends.

The technical effect of method 500 is to adjust pressure of hydrogen gas components within a redox flow battery system by operation of one or more hydrogen blower assemblies. Energized components of the one or more hydrogen blower assemblies may be fluidly separated from flow of hydrogen gas to prevent ignition of the hydrogen gas. Further power may be delivered to the one or more of the hydrogen blower assemblies as needed to reduce an overall power demand. The hydrogen blower assemblies may allow for movement of hydrogen with a smaller footprint and lower power consumption than using a combination of venturi/educator valves, liquid pumps, and liquid/gas separators.

The disclosure also provides support for an electrochemical cell system, comprising: a component configured to receive hydrogen gas, one or more hydrogen blower assemblies, wherein the one or more hydrogen blower assemblies are positioned upstream and/or downstream of the component, and wherein the one or more hydrogen blower assemblies include at least one sensor positioned on an outer surface of the one or more hydrogen blower assemblies, and a controller, including executable instructions stored on non-transitory memory that, when executed, cause the controller to: generate a notification in response to an output of the at least one sensor being outside of a target range. In a first example of the system, the component configured to receive hydrogen gas is a rebalancing reactor of the electrochemical cell system. In a second example of the system, optionally including the first example, a hydrogen gas storage container is positioned downstream of the component, and wherein one of the one or more hydrogen blower assemblies is positioned between the hydrogen gas storage container and the component. In a third example of the system, optionally including one or both of the first and second examples, the one or more hydrogen blower assemblies includes an impeller suspended by bearings within a housing of the one or more hydrogen blower assemblies. In a fourth example of the system, optionally including one or more or each of the first through third examples, the bearings are formed of ceramic. In a fifth example of the system, optionally including one or more or each of the first through fourth examples, the impeller includes a balancing hole. In a sixth example of the system, optionally including one or more or each of the first through fifth examples, the at least one sensor is one or more of a vibration sensor, temperature sensor, and a hydrogen gas sensor.

The disclosure also provides support for a method of operating an electrochemical cell system, comprising: responsive to a demand for hydrogen gas at a component of the electrochemical cell system, energizing a hydrogen blower assembly to rotate an impeller of the hydrogen blower assembly, adjusting a flow rate of the hydrogen gas by modifying a power supplied to a driver of the hydrogen blower assembly to vary a rate of rotation of the impeller, responsive to an output of a sensor or an input of the hydrogen blower assembly being outside of a target range, adjust an operating condition of the electrochemical cell system and/or generate a notification. In a first example of the method, the sensor of the hydrogen blower assembly is one or more of a vibration sensor, temperature sensor, and a hydrogen gas sensor. In a second example of the method, optionally including the first example, the hydrogen blower assembly is positioned downstream and/or upstream of the component of the electrochemical cell system. In a third example of the method, optionally including one or both of the first and second examples, adjusting the flow rate includes adjusting the flow rate in response to a hydrogen flow rate being outside of a target flow rate range. In a fourth example of the method, optionally including one or more or each of the first through third examples, the flow rate is determined based on a speed of the driver. In a fifth example of the method, optionally including one or more or each of the first through fourth examples, the input of the hydrogen blower assembly is an electrical current demand of the driver of the hydrogen blower assembly.

The disclosure also provides support for an electrochemical cell system, comprising: at least one hydrogen gas storage container, a component demanding hydrogen gas from the at least one hydrogen gas storage container, a hydrogen blower assembly configured to pump hydrogen from the at least one hydrogen gas storage container to the component, wherein the hydrogen blower assembly includes an impeller positioned inside a hermetically sealed housing and a driver positioned outside of the hermetically sealed housing, and a controller, including executable instructions stored on non-transitory memory that, when executed, cause the controller to: energize the driver of the hydrogen blower assembly in response to a demand for hydrogen gas by the component, and in response to a flow rate of hydrogen being outside of a target range, adjust a power delivered to the driver of the hydrogen blower assembly. In a first example of the system, the hermetically sealed housing is formed of a top housing and a bottom housing, and wherein the top housing is secured to the bottom housing and is sealed by one of an o-ring is positioned between the top housing and the bottom housing, a weld, or glue. In a second example of the system, optionally including the first example, the hermetically sealed housing includes a water trap configured to collect water condensing inside of the hermetically sealed housing. In a third example of the system, optionally including one or both of the first and second examples, hydrogen blower assembly further includes a drive coupler positioned outside of the hermetically sealed housing and physically coupled to the driver, and wherein the drive coupler is magnetically coupled to the impeller. In a fourth example of the system, optionally including one or more or each of the first through third examples, the driver is a brushless DC motor or a magnetic field generator. In a fifth example of the system, optionally including one or more or each of the first through fourth examples, the at least one hydrogen gas storage container is a gas head space of a multi-chambered electrolyte storage tank or a supplementary hydrogen gas tank. In a sixth example of the system, optionally including one or more or each of the first through fifth examples, the hydrogen blower assembly further includes a suspended bearing positioned between a stem of the impeller and a flared portion of the hermetically sealed housing.

The disclosure also provides support for a hydrogen blower assembly, comprising, a hermetically sealed housing, an impeller positioned within the hermetically sealed housing, a stem of the impeller coupled to the hermetically sealed housing by suspended bearings, and a driver positioned outside the hermetically sealed housing and configured to rotate the impeller to propel hydrogen gas. In a first example of the system, the hermetically sealed housing includes a top housing and a bottom housing, the top housing secured to the bottom housing by one of a weld, glue, or an o-ring. In a second example of the system, optionally including the first example, the impeller includes balancing hole configured to mitigate axial thrust of the impeller. In a third example of the system, optionally including one or both of the first and second examples, the stem of the impeller includes magnets and the impeller is configured to rotate by action of magnetic forces. In a fourth example of the system, optionally including one or more or each of the first through third examples, the impeller is spaced away from inner faces of the hermetically sealed housing. In a fifth example of the system, optionally including one or more or each of the first through fourth examples, the suspended bearings are secured to an inner surface of the hermetically sealed housing by one of press-fit, snap-fit, or glue.

The disclosure also provides support for a hydrogen blower assembly, comprising: a housing formed of a first housing piece and a second housing piece, wherein the first housing piece and the second housing piece are substantially the same shape, an impeller suspended within the housing, wherein the impeller is symmetric a radial axis, a driver configured to couple to an outer surface of the first housing piece and the second housing piece. In a first example of the system, the housing includes a gasket positioned between the first housing piece and the second housing piece. In a second example of the system, optionally including the first example, the housing includes a first inlet/outlet port and a second inlet/outlet port positioned on a same radial side of the housing. In a third example of the system, optionally including one or both of the first and second examples, the first inlet/outlet port and the second inlet/outlet port are each coupled at a first end to a flange or quick-connect port at one end and coupled to a cap at a second end. In a fourth example of the system, optionally including one or more or each of the first through third examples, the first inlet/outlet port and the second inlet/outlet port are each coupled at a first end to a flange or quick-connect port at one end and fluidly coupled to an adjacent hydrogen blower assembly at a second end. In a fifth example of the system, optionally including one or more or each of the first through fourth examples, the first inlet/outlet port and the second inlet/outlet port are configured for cross-axial loading of the impeller. In a sixth example of the system, optionally including one or more or each of the first through fifth examples, blades of the impeller are formed without undercuts.

The disclosure also provides support for an electrochemical cell system, comprising: at least one hydrogen gas storage container, a component demanding hydrogen gas from the at least one hydrogen gas storage container, and a hydrogen blower assembly configured to pump from at least one hydrogen gas storage container to the component, wherein the hydrogen blower assembly is comprised of a symmetrical impeller including a first stem and a second stem. In a first example of the system, blade angles of the symmetrical impeller are in a range of −45° to 45°. In a second example of the system, optionally including the first example, stem diameter of the symmetrical impeller are in a range of 3 mm to 100 mm. In a third example of the system, optionally including one or both of the first and second examples, the hydrogen blower assembly is configured as a regenerative blower. In a fourth example of the system, optionally including one or more or each of the first through third examples, the hydrogen blower assembly includes a stripper section and a length of the stripper section is in a range between 3 mm and 200 mm. In a fifth example of the system, optionally including one or more or each of the first through fourth examples, the system further comprises: a driver coupled to the hydrogen blower assembly and an adjacent hydrogen blower assembly. In a sixth example of the system, optionally including one or more or each of the first through fifth examples, the component demanding hydrogen gas is a rebalancing reactor.

FIGS. 2-4 and FIGS. 6-9 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-4 and 6-9 are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A hydrogen blower assembly, comprising;
a hermetically sealed housing;
an impeller positioned within the hermetically sealed housing, a stem of the impeller coupled to the hermetically sealed housing by suspended bearings; and
a driver positioned outside the hermetically sealed housing and configured to rotate the impeller to propel hydrogen gas.

2. The hydrogen blower assembly of claim 1, wherein the hermetically sealed housing includes a top housing and a bottom housing, the top housing secured to the bottom housing by one of a weld, glue, or an o-ring.

3. The hydrogen blower assembly of claim 1, wherein the impeller includes balancing hole configured to mitigate axial thrust of the impeller.

4. The hydrogen blower assembly of claim 1, wherein the stem of the impeller includes magnets and the impeller is configured to rotate by action of magnetic forces.

5. The hydrogen blower assembly of claim 1, wherein the impeller is spaced away from inner faces of the hermetically sealed housing.

6. The hydrogen blower assembly of claim 1, wherein the suspended bearings are secured to an inner surface of the hermetically sealed housing by one of press-fit, snap-fit, or glue.

7. A hydrogen blower assembly, comprising:
a housing formed of a first housing piece and a second housing piece, wherein the first housing piece and the second housing piece are substantially the same shape;
an impeller suspended within the housing, wherein the impeller is symmetric a radial axis; and
a driver configured to couple to an outer surface of the first housing piece and the second housing piece.

8. The hydrogen blower assembly of claim 7, wherein the housing includes a gasket positioned between the first housing piece and the second housing piece.

9. The hydrogen blower assembly of claim 7, wherein the housing includes a first inlet/outlet port and a second inlet/outlet port positioned on a same radial side of the housing.

10. The hydrogen blower assembly of claim 9, wherein the first inlet/outlet port and the second inlet/outlet port are each coupled at a first end to a flange or quick-connect port at one end and coupled to a cap at a second end.

11. The hydrogen blower assembly of claim 9, wherein the first inlet/outlet port and the second inlet/outlet port are each coupled at a first end to a flange or quick-connect port at one end and fluidly coupled to an adjacent hydrogen blower assembly at a second end.

12. The hydrogen blower assembly of claim 9, wherein the first inlet/outlet port and the second inlet/outlet port are configured for cross-axial loading of the impeller.

13. The hydrogen blower assembly of claim 7, wherein blades of the impeller are formed without undercuts.

14. An electrochemical cell system, comprising:
at least one hydrogen gas storage container;
a component demanding hydrogen gas from the at least one hydrogen gas storage container; and
a hydrogen blower assembly configured to pump from at least one hydrogen gas storage container to the component, wherein the hydrogen blower assembly is comprised of a symmetrical impeller including a first stem and a second stem.

15. The electrochemical cell system of claim 14, wherein blade angles of the symmetrical impeller are in a range of −45° to 45°.

16. The electrochemical cell system of claim 14, wherein stem diameter of the symmetrical impeller are in a range of 3 mm to 100 mm.

17. The electrochemical cell system of claim 14, wherein the hydrogen blower assembly is configured as a regenerative blower.

18. The electrochemical cell system of claim 14, wherein the hydrogen blower assembly includes a stripper section and a length of the stripper section is in a range between 3 mm and 200 mm.

19. The electrochemical cell system of claim 14, further comprising a driver coupled to the hydrogen blower assembly and an adjacent hydrogen blower assembly.

20. The electrochemical cell system of claim 14, wherein the component demanding hydrogen gas is a rebalancing reactor.
